(19) United States
(12) Patent Application Publication
(10) Pub. No.: US 2017/0337160 A1
(43) Pub. Date: Nov. 23, 2017

(54) READING COMPREHENSION ASSISTANCE APPARATUS, AND READING COMPREHENSION ASSISTANCE METHOD

(71) Applicant: FUJITSU LIMITED, Kawasaki-shi (JP)

(72) Inventors: Takeaki Terada, Kawasaki (JP); Satoru Torii, Yokohama (JP); Hiroshi Tsuda, Fujisawa (JP); Yoshinori Katayama, Kawasaki (JP)

(73) Assignee: FUJITSU LIMITED, Kawasaki-shi (JP)

(21) Appl. No.: 15/581,552

(22) Filed: Apr. 28, 2017

(30) Foreign Application Priority Data
May 18, 2016 (JP) 2016-099494

(51) Int. Cl. G06F 17/21; G09B 5/02

(52) U.S. Cl. CPC G06F 17/211; G09B 5/02

(57) ABSTRACT

A disclosed reading comprehension assistance apparatus includes one or more processors programmed to execute a process. The process includes acquiring information indicating behavior with respect to attention portions of respective users who read a document, specifying a user who properly reads the document based on the acquired information indicating behavior of the attention portions, estimating one or more high attention portions having attention focused on by the high-reliability users who have properly read the document based on the information indicating the behavior with respect to the attention portions, and presenting the one or more high attention portions.

### CROSS-REFERENCE TO RELATED APPLICATION

This patent application is based upon, and claims the benefit of priority of Japanese Patent Application No. 2016-099494 filed on May 18, 2016, the entire contents of which are incorporated herein by reference.

### FIELD

The embodiments discussed herein relate to a reading comprehension assistance apparatus, and a reading comprehension assistance method.

### BACKGROUND

In the use of applications, web services, etc., users are expected to have obligations to carefully read documents such as terms of use and privacy policy. Users may thus be in charge of their responsibility when they violate rules and regulations. However, documents such as terms of use are long and difficult to understand, and many users feel confirmation of the terms burdensome, and may start using services, etc., without fully understanding conditions of use; some users may suffer an unreasonable loss later as a result.

For example, in a case of terms of use for SNS (Social Networking Service), such terms may include wordings such as transmitting to a large number of unspecified people information about opening of an event accompanied by some kind of money transfer via the SNS, i.e., prohibiting the use of SNS for sales purposes. Such behavior may be accidentally performed by general users, and the users may suffer an unreasonable loss if they do not thoroughly read and understand such terms of use. As another example, there may be a case where a user does not thoroughly read the terms in selecting a course of voluntary insurance of a car. In such a case, the user may select a course that is not accompanied by personal injury protection coverage (including compensation for injured fellow passengers).

When document creators ambiguously describe terms and the like so as to be interpreted differently among people, it becomes disadvantageous for the document creators to have disputes over different interpretations. The description of the terms may thus be specific and the document becomes long and difficult as a result. Nevertheless, the document creators would also like to minimize the cost corresponding to complaints and inquiries from users.

Meanwhile, there is known in the art a technology for improving a user interface of a screen to direct users' attention on important points by highlighting or the like in order to encourage users' understanding of display contents (see Patent Documents 1 to 3).

### RELATED ART DOCUMENTS

### Patent Documents

Patent Document 1: WO 03/103564

Patent Document 2: Japanese Laid-open Patent Publication No. 2010-55231

Patent Document 3: Japanese Laid-open Patent Publication No. 2014-63483

### SUMMARY

According to an aspect of the embodiments, a reading comprehension assistance apparatus includes a reading comprehension assistance apparatus having one or more processors programmed to execute a process. The process includes acquiring information indicating behavior with respect to attention portions of respective users who read a document; specifying a user who properly reads the document based on the acquired information indicating behavior of the attention portions; estimating one or more high attention portions having attention focused on by the high-reliability users who have properly read the document based on the information indicating the behavior with respect to the attention portions; and presenting the one or more high attention portions.

The object and advantages of the invention will be realized and attained by means of the elements and combinations particularly pointed out in the appended claims.

It is to be understood that both the foregoing general description and the following detailed description are exemplary and explanatory and are not restrictive of the invention.

Additional objects and advantages of the embodiments will be set forth in part in the description which follows, and in part will be obvious from the description, or may be learned by practice of the invention.

### BRIEF DESCRIPTION OF THE DRAWINGS

FIG. 1 is a diagram illustrating a configuration example of a system according to an embodiment;

FIG. 2 is a diagram illustrating a functional configuration example of a terms server;

FIG. 3 is a diagram illustrating a functional configuration example of an analysis server;

FIG. 4 is a diagram illustrating an example of a functional configuration of a terminal;

FIG. 5 is a diagram illustrating a hardware configuration example of a terms server, an analysis server, and a terminal;

FIG. 6 is a sequence diagram illustrating a process example according to an embodiment;

FIG. 7 is a diagram illustrating an example of a behavior log;

FIG. 8 is a diagram illustrating an example of a terms-specific word DB;

FIG. 9 is a diagram illustrating an example of a terms reading-comprehension log;

FIG. 10 is a diagram illustrating an example of an aggregated log;

FIG. 11 is a diagram illustrating an example of an attention portion DB; and

FIG. 12 is a diagram illustrating an example of an attention portion presentation.

### DESCRIPTION OF EMBODIMENTS

Documents such as terms of use or the like are difficult to read because it is difficult to simplify the description due to the importance of contents and the like of such documents. Thus, it has been desired to have a system that enables users to recognize important information in the document as well as facilitating document readability of the users.

In this case, it is generally difficult for a document creator to evaluate the importance levels of different parts of the document from the document creator's viewpoint and position in order to make important information stand out by highlighting or the like. The document will thus have many parts that are considered to be of importance. As a result, the users will disregard the highlight or the like, which no longer makes sense to the users, and it will become difficult to substantially raise the recognition rate for important information.

Thus, it is an object in one aspect of embodiments to assist in raising a recognition rate of important information in a document.

The following illustrates preferred embodiments with reference the accompanying drawings. It should be noted that the following description includes the terms of use as an example of a document to be viewed; however, any documents other than the terms of use may be a document to be viewed.

Configuration

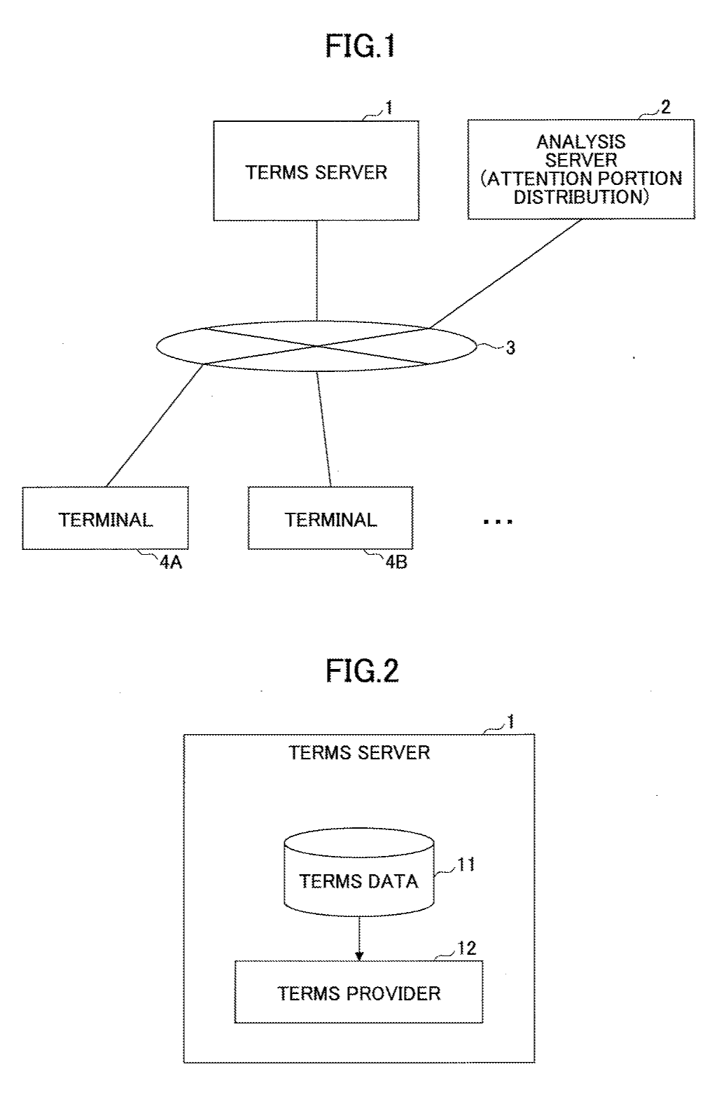

FIG. 1 is a diagram illustrating a configuration example of a system according to an embodiment.

In FIG. 1, a network 3 such as the Internet is communicatively connected to each of a terms server 1 configured to provide information on the terms of use and enable browsing of the terms, an analysis server 2 configured to assist a reading comprehension of the terms, and terminals 4A, 4B, . . . used by users to browse the terms of use.

FIG. 2 is a diagram illustrating a functional configuration example of the terms server 1. In FIG. 2, the terms server 1 includes a terms provider 12 configured to provide corresponding terms data from terms data 11 in response to a request from the terminal 4 (4A, 4B, . . . ).

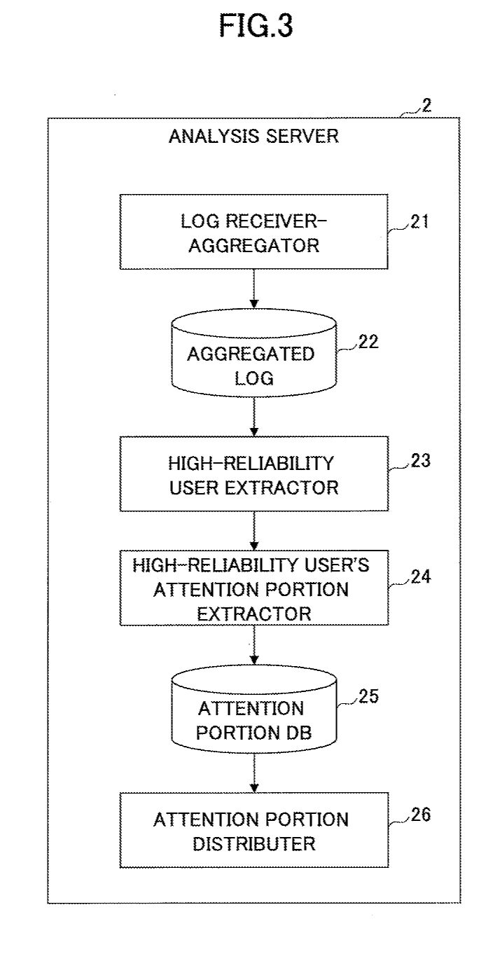

FIG. 3 is a diagram illustrating a functional configuration example of the analysis server 2. In FIG. 3, the analysis server 2 includes a log receiver-aggregator 21, a high-reliability user extractor 23, a high-reliability user's attention portion extractor 24, and an attention portion distributer 26.

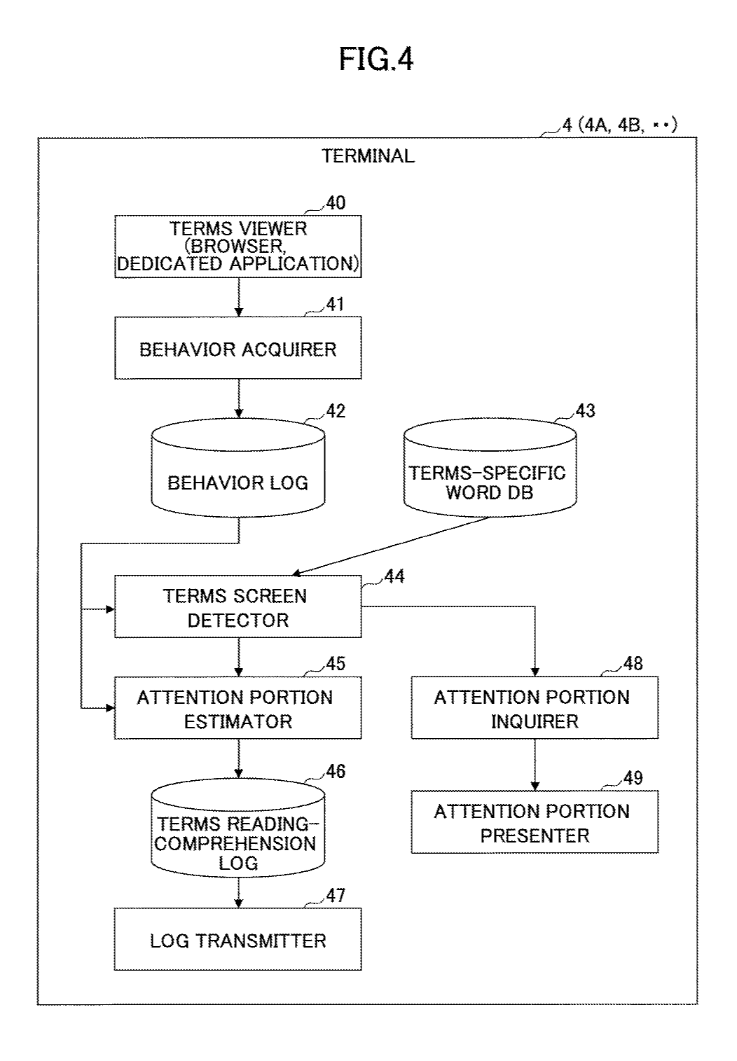

The log receiver-aggregator 21 has a function to receive a terms reading-comprehension log (46) (see FIG. 4) from each of multiple (a large number of) terminals 4 and to output aggregated log 22 obtained by aggregating the terms reading-comprehension logs of the multiple (a large number of) users. The high-reliability user extractor 23 has a function to specify a user (a high-reliability user) who has properly read the document and extract the specified user, based on a time during which the terms have been read (a total reference time of referring to the terms), a range of the document (whether the document has been read to the end), or other information (whether the document has been uniformly read without being partially skipped) from the aggregated log 22.

The high-reliability user's attention portion extractor 24 has a function to extract a high attention portion having attention focused on by multiple high-reliability users within the terms (an overlapped portion of character strings having attention focused on by multiple high-reliability users), to calculate, as indices of attention levels, a mean attention time, an attention ratio and the like of the high-reliability users, and to output the calculated mean attention time, attention ratio and the like to the attention portion DB 25. The attention portion distributer 26 has a function to provide, in response to a request from the terminal 4, information on an attention portion of the corresponding terms stored in the attention portion DB 25.

FIG. 4 is a diagram illustrating an example of a functional configuration of the terminal 4 (4A, 4B, . . . ). In FIG. 4, the terminal 4 includes a terms viewer 40, a behavior acquirer 41, a terms screen detector 44, an attention portion estimator 45, a log transmitter 47, an attention portion inquirer 48, and an attention portion presenter 49.

The terms viewer 40 serves as a general-purpose browser or a dedicated application, which has a function to access the terms server 1 to browse the terms. The behavior acquirer 41 has a function to monitor the activation of the terms viewer 40 and acquire information indicating the behavior of the user's operation such as scrolling of the screen during activation and a position of the mouse cursor to output the acquired information to a behavior log 42. The terms screen detector 44 has a function to detect a terms-of-use screen by referring to the behavior log 42 to match the character string of the title bar or the character string of the terms text file on the display screen of the terms viewer 40 and a terms-specific word retained in a terms-specific word DB 43 in association with the terms ID.

The attention portion estimator 45 estimates the attention portion of the user in the terms text from a retaining state of the attention position and obtains an attention time (a reference time) based on the behavior log 42, and then outputs information including the attention portion, attention time and the like to the terms reading-comprehension log 46. The output information may include other information such as run the mouse cursor over the character string. The log transmitter 47 has a function to transmit contents of the terms reading-comprehension log 46 to the analysis server 2 at a predetermined timing.

The attention portion inquirer 48 has a function to acquire information about the attention portion. When the terms screen detector 44 detects that the user is reading the terms, the attention portion inquirer 48 transmits to the analysis server 2 an inquiry about whether there is information about the attention portion of the high-reliability user who has previously read the same terms, and acquire, when there is such information, the information about the attention portion of the high-reliability user who has previously read the same terms. The attention portion presenter 49 has a function to present information on the attention portion to the user when the attention portion inquirer 48 has acquired the information on the attention portion.

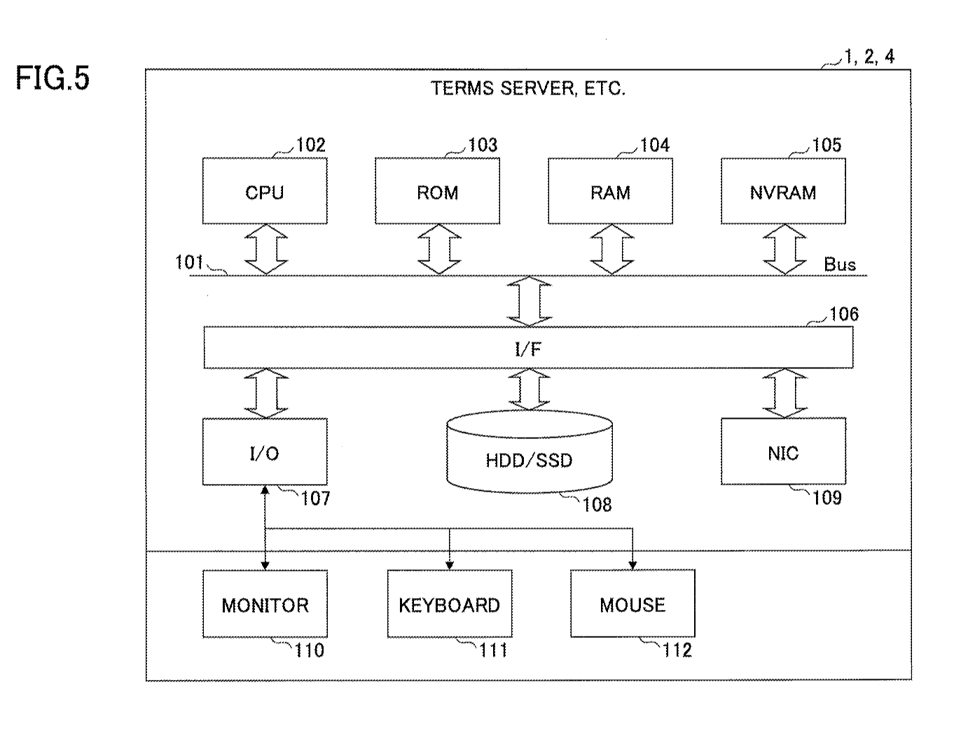

FIG. 5 is a diagram illustrating a hardware configuration example of a terms server 1, an analysis server 2, and a terminal 4. In FIG. 5, the terms server 1 and the like (i.e., the analysis server 2 and the terminal 4) include a CPU (Central Processing Unit) 102, a ROM (Read Only Memory) 103, a RAM (Random Access Memory) 104, a NVRAM (Non-Volatile Random Access Memory) 105 that are coupled to a system bus 101. The terms server 1 and the like further include an I/F (Interface) 106, an I/O (Input/Output Device) 107, a HDD (Hard Disk Drive)/SSD (Solid State Drive) 108 connected to I/F 106, and a NIC (Network Interface Card) 109. Further, a monitor 110, a keyboard 111, a mouse 112 and the like are connected to the I/O 107. Instead of the keyboard 111 and the mouse 112, a touch panel may be used. A CD/DVD (Compact Disk/Digital Versatile Disk) drive or the like may also be connected to the I/O 107.

The functions of the terms server 1 and the like described in FIGS. 2 to 4 are implemented by causing the CPU 102 to execute a predetermined program. The program may be acquired via a recording medium, may be acquired via a network, or may be embedded in a ROM. More specifically, a program for operating the terms provider 12 of the terms server 1 in FIG. 2 is stored in the HDD/SSD 108, loaded in the RAM 104 at the time of execution, and executed by the CPU 102. The terms data 11 is temporarily retained in the RAM 104 and is permanently stored in the HDD/SSD 108.

Programs for operating the log receiver-aggregator 21, the high-reliability user extractor 23, the high-reliability user's attention portion extractor 24 and the attention portion distributer 26 of the analysis server 2 in FIG. 3 are stored in the HDD/SSD 108, which are loaded in the RAM 104 and executed by the CPU 102. The aggregated log 22 and the attention portion DB 25 are temporarily retained in the RAM 104 and are permanently stored in the HDD/SSD 108. Programs for operating the terms viewer 40, the behavior acquirer 41, the terms screen detector 44, the attention portion estimator 45, the log transmitter 47, the attention portion inquirer 48 and the attention portion presenter 49 of the terminal 4 in FIG. 4 are stored in the HDD/SSD 108. These programs are loaded in the RAM 104 at the time of execution and executed by the CPU 102. The behavior log 42, the terms-specific word DB 43 and the terms reading-comprehension log 46 are temporarily retained in the RAM 104 and are permanently stored in the HDD/SSD 108.

Operations

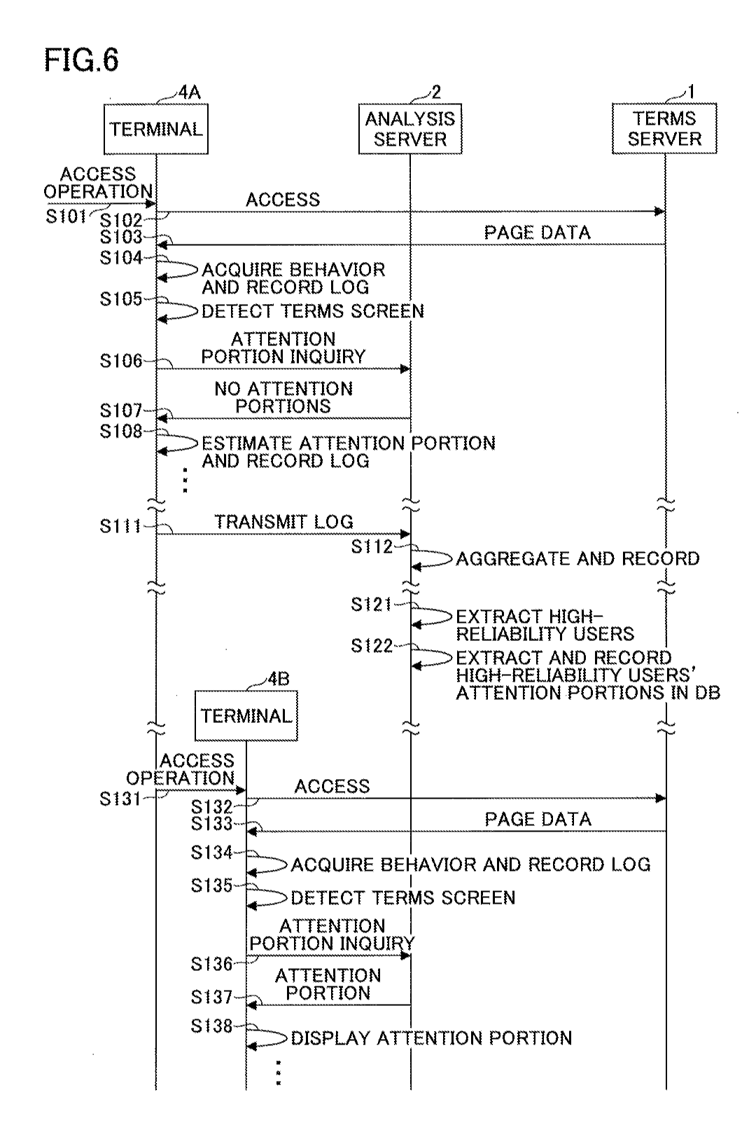

FIG. 6 is a sequence diagram illustrating an example of processing according to the embodiment. In FIG. 6, when the user of the terminal 4A performs an access operation by designating a URL (Uniform Resource Locator) of a terms page or selecting a link from another page on the terms viewer 40 (step S101), the terms viewer 40 accesses the terms server 1 (step S102). The terms server 1 responds with the terms page data (step S103), and the terminal 4A displays the page data.

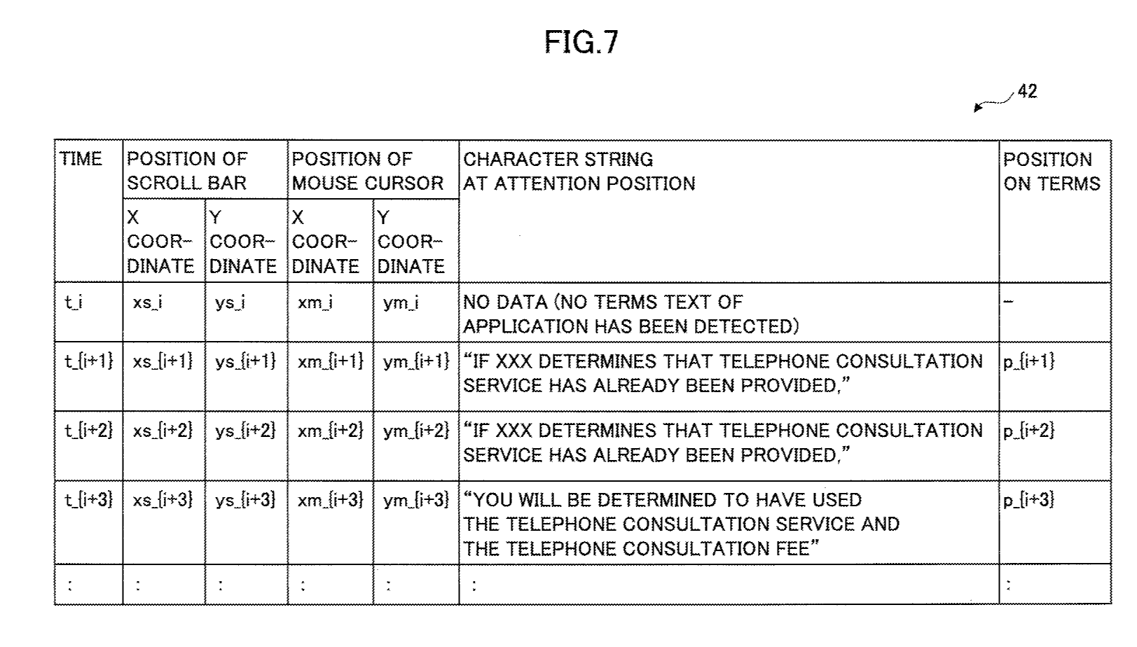

Information indicating behavior of the user operation is acquired by the behavior acquirer 41 and recorded in the behavior log 42 (step S104). FIG. 7 illustrates an example of the behavior log 42 that includes “time” at which behavior information is acquired, a “position of a scroll bar” (X coordinate, and Y coordinate), a “position of a mouse cursor” (X coordinate, and Y coordinate), a “character string at the attention position”, a “position on the terms” and the like at that time. The character string (acquired from a file such as a HyperText Markup Language (HTML) to be displayed on the screen) displayed on a title bar of the screen may be included. In a case of a touch panel terminal having no mouse, the position of the mouse cursor is to be read as a touch position.

It is assumed in this example that a character string at the attention position acquires a character string of one line of the line on which the mouse cursor is placed; however, a character string of a predetermined number of characters before and after the character on which the mouse cursor is placed may be acquired or a character string cut out at a portion where a punctuation mark, a particle or the like is recognized and separated at a delimited position may be obtained. These strings are acquired from a file such as HTML serving as a source to be displayed on the screen. The position on the terms indicates the position (line position, character position, etc.) in the file of the terms of the representative position (head, center, tail, etc.) of the character string at the attention position. The position on the terms is acquired from a file such as HTML serving as a source to be displayed on the screen. The position on the terms may be accompanied by a total amount of the terms. This enables a user to check a current position of all the terms to which the terms has been read. Since a correspondence between the “position of the scroll bar” or the “position of the mouse cursor” and the “character string” changes depending on the size of the display screen and the font size of the character, such a correspondence will not be used as an absolute position index; however, the correspondence may be used to specify the position. Accordingly, the “position of the scroll bar” or the “position of the mouse cursor” may be managed as the “position on the terms”. In this case, matching of the character string needs to be determined to specify a rigorous position.

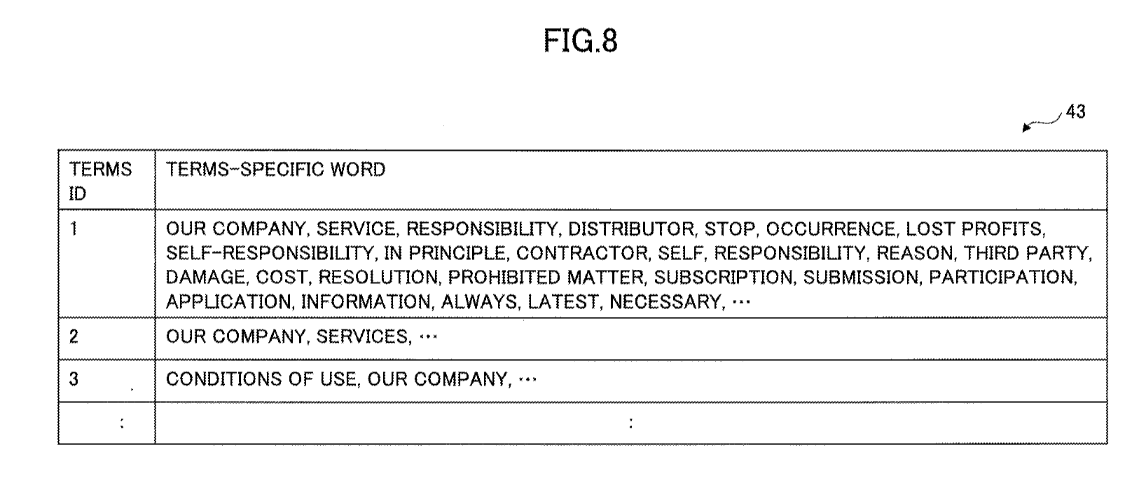

Referring back to FIG. 6, the terms screen detector 44 compares a character string at an attention position of the behavior log 42 or a character string of a title bar of the display screen with a terms-specific word of the terms-specific word DB 43. This comparison enables the terms screen detector 44 to detect a currently displayed terms screen and specify a terms ID (step S105). FIG. 8 illustrates an example of the terms-specific word DB 43, and words appearing in the terms-specific word DB 43 are registered as a “terms-specific word” for each “terms ID” to specify each of rules included in the terms to be managed. Each of the rules in the terms is specified by matching or mismatching of one or more terms-specific words.

Referring back to FIG. 6, when the terms screen is detected by the terms screen detector 44, the attention portion inquirer 48 designates the terms ID and queries the analysis server 2 about an attention portion (step S106). In response to this inquiry, the attention portion distributer 26 of the analysis server determines whether the attention portion associated with the designated terms ID is registered in the attention portion DB 25. In this case, it is assumed that the analysis server 2 has detected no attention portion associated with the designated terms ID, and reports such a result as a response (step S107). In this case, no attention portion will be presented.

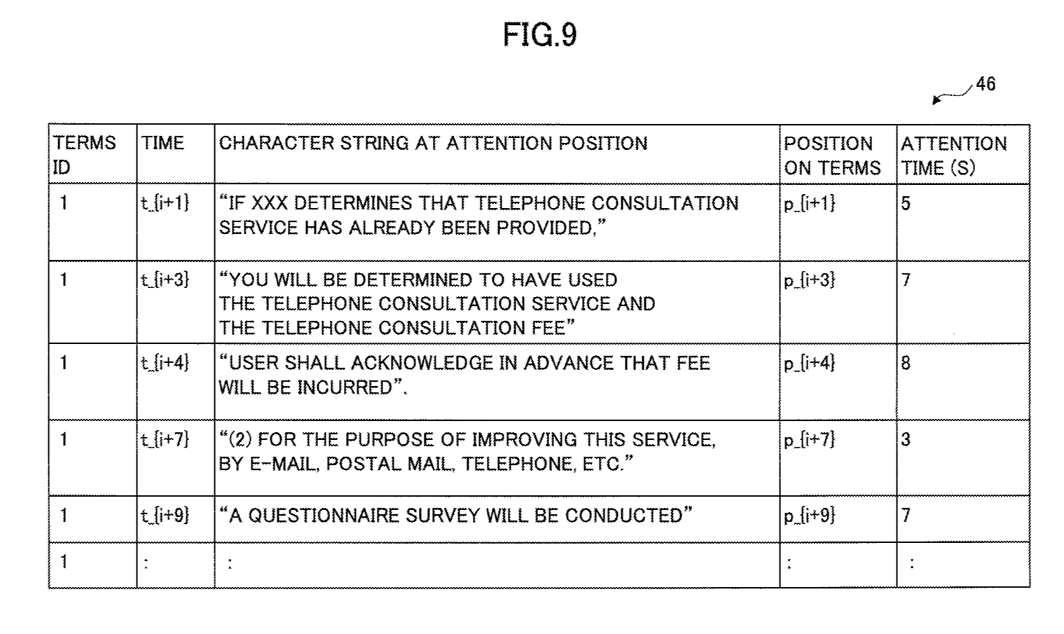

Next, based on the behavior log 42, the attention portion estimator 45 estimates the attention portion of the user in the terms text from a retaining state of the attention position, obtains an attention time (a reference time), and outputs the obtained attention time to a terms reading-comprehension log 46 (step S108). FIG. 9 illustrates an example of the terms reading-comprehension log 46, which includes “terms ID”, “time”, “character string at an attention position”, “position on terms” and “attention time”. In this example, for each behavior data of the behavior log 42 illustrated in FIG. 7, the attention portion estimator 45 estimates the match or slight mismatch between the character strings at the attention position among those character strings associated with the specified terms ID. The attention portion estimator 45 aggregates behavior instances that have been continuously having attention focused on and outputs an aggregated result to the terms reading-comprehension log 46 illustrated in FIG. 4. That is, the “terms ID” is specified by the terms screen detector 44, “time” is a first time of the aggregated behavior instances, a “character string at the attention position” is aggregated character strings, a “position on the terms” is a position (representative position) of the aggregated character strings, and an “attention time” is a time during which a user continuously pays attention.

Referring to FIG. 6, the log transmitter 47 subsequently transmits content of the terms reading-comprehension log 46 together with the user ID to the analysis server at a predetermined timing (step S111). Examples of the predetermined timing may include every time the terminal 4A accesses the terms server 1, at the end of accessing the terms viewer 40, and at predetermined time intervals.

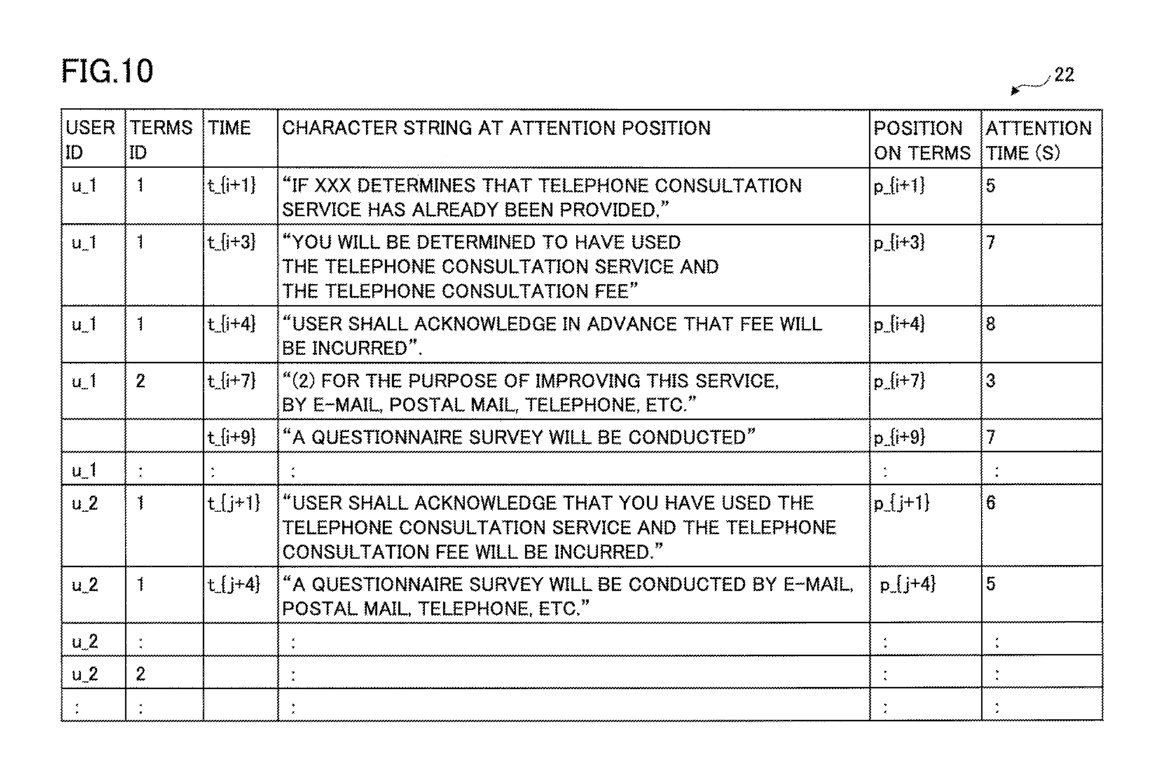

Upon reception of a log, the log receiver-aggregator 21 of the analysis server 2 aggregates multiple logs received immediately before and after the currently received log, and outputs the aggregated logs to the aggregated log 22 (step S112). FIG. 10 illustrates an example of the aggregated log 22, which is stored by assigning corresponding user IDs to the same contents as those of the terms reading-comprehension log 46 illustrated in FIG. 9.

Referring back to FIG. 6, the high-reliability user extractor 23 specifies a user who properly reads a document based on the time during which the user reads the terms, a document range, or other information, and extracts such a user (high-reliability user) at a predetermined timing from the aggregated log (step S121). Whether a user has read the terms properly is determined for each terms ID based on information corresponding to a user ID obtained from the aggregated log 22 illustrated in FIG. 10, as noted below. That is, a total reference time, during which a user reads the terms text from the beginning to the end, is obtained based on a first reference time at which a user starts referring to the terms text and a last reference time at which the user ends referring to the terms text. Subsequently, whether a total reference time of each user exceeds a predetermined time period is determined. When the obtained total reference time of the user exceeds the predetermined time period, the user is determined to have read the terms properly (a high-reliability user). Further, in the case where a total amount of the terms is added to a position on the terms, and the position on the terms at the last reference time has almost reached the end of the terms, the user is determined to have read the terms properly.

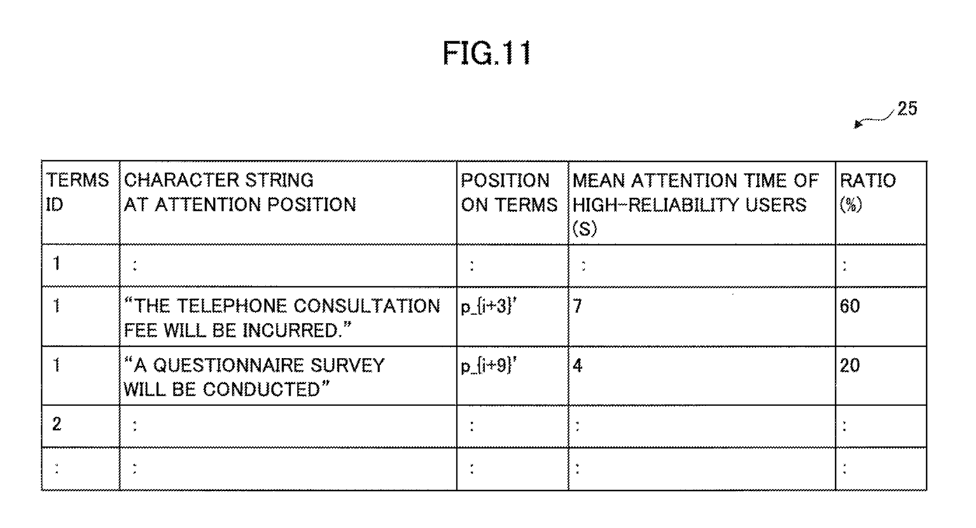

Referring back to FIG. 6, the high-reliability user's attention portion extractor 24 extracts a high attention portion having attention focused on by multiple high-reliability users within the terms (an overlapped portion of character strings having attention focused on by the multiple high-reliability users), calculates, as indices of attention levels, a mean attention time, an attention ratio and the like of the high-reliability users, and outputs the calculated mean attention time, attention ratio and the like to the attention portion DB 25 (step S122). FIG. 11 illustrates an example of the attention portion DB 25, which includes a “terms ID”, “character string at an attention position”, “position on terms”, “mean attention time (s) of a high-reliability user”, and “ratio (%)”. In this example, the high-reliability user's attention portion extractor 24 obtains an overlapped portion of the character strings at the attention position for each terms ID with respect to behavior instances of the high-reliability users extracted by the high-reliability user extractor 23, registers the obtained overlapped portion in the “character string at the attention position”, and registers the position on the terms corresponding to the overlapped portion in the “position on the terms”. Further, a mean of the attention time of each high-reliability user at that time is registered in the “mean attention time (s) of high-reliability users”. The high-reliability user's attention portion extractor 24 registers a ratio of the number of high-reliability users who have performed the behavior instances to a total number of high-reliability users, for each terms ID, in the “ratio (%)”.

Referring back to FIG. 6, when a user of another terminal 4B performs an access operation by designating a URL of a terms page or selecting a link from another page on the terms viewer 40 (step S131), the terms viewer 40 accesses the terms server 1 (step S132). The terms server 1 responds with the terms page data (step S133), and the terminal 4B displays the page data.

Information indicating behavior instances of the user operation is acquired by the behavior acquirer 41 and recorded in the behavior log 42 (step S134).

Subsequently, the terms screen detector 44 compares a character string at an attention position of the behavior log 42 or a character string of a title bar of the display screen with a terms-specific word of the terms-specific word DB 43. This comparison enables the terms screen detector 44 to detect a currently displayed terms screen and specify a terms ID (step S135).

When the terms screen is detected by the terms screen detector 44, the attention portion inquirer 48 designates the terms ID and queries the analysis server 2 about an attention portion (step S136). In response to this inquiry, the attention portion distributer 26 of the analysis server 2 determines whether the attention portion distributer 26 of the analysis server 2 determines whether the attention portion the designated terms ID is registered in the attention portion DB 25. In this case, it is assumed that there is an attention portion corresponding to the designated terms ID and the attention portion is returned (step S137).

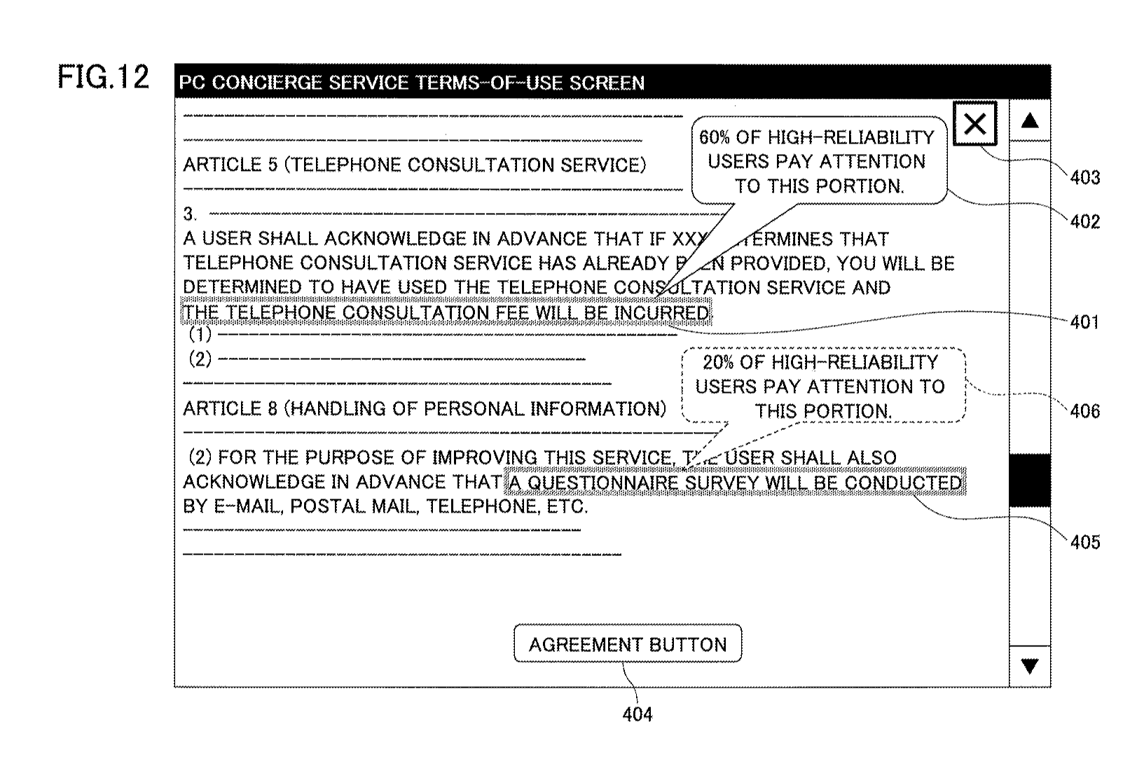

In response to this return, the attention portion presenter 49 of the terminal 4 presents an attention attracting display by highlighting the overlapped portion of the terms text or pop-up overlay display (step S138). FIG. 12 illustrates an example of attention portion presentation, which corresponds to an attention portion of the terms ID “1” in the attention portion DB 25 shown in FIG. 11. That is, in FIG. 12, for example, a character string portion 401 of “the telephone consultation fee will be incurred” is marked in red, and a pop-up 402 presents a comment of “60% of high-reliability users pay attention to this portion” is displayed. Further, a close button 403 is disposed on the pop-up 402, and unless confirmation is performed by clicking on this close button 403, an agreement button 404 will not be allowed to be pressed. Note that a highly important character string portion marked in red to attract such attention corresponds, for example, to top three items having the greater length of the mean attention time of the high-reliability users in the attention portion DB 25 (FIG. 11).

For an attention portion next to the top three items, for example, a popup is displayed in yellow and no close button is provided. That is, in FIG. 12, for example, a character string portion 405 of “the telephone consultation fee will be incurred” is marked in red, and a pop-up 406 presents a comment of “60% of high-reliability users pay attention to this portion” is presented. Furthermore, the pop-up comment may be accompanied by the identity of each of high-reliability users (affiliated department, title, age group, etc.).

As described above, since an added value of an attention portion where those users who read the terms properly is provided in the terms text, a user may be able to read the long terms text with awareness. Since the terms text is accompanied by identities of the users who properly read information and the terms of what percentage of these users who read the terms is paying attention to a particular portion of the terms may further enhance awareness of a user who reads the terms due to a sense of affinity or authority orientation.

Referring back to FIG. 6, when the attention portion is estimated for users of the terminal 4B after the presentation of the attention portion, a result of the estimation is output to the terms reading-comprehension log 46, which is subject to analysis in the analysis server 2.

Overview

As described above, the disclosed technology according to the embodiments, based on behavior of a user who properly reads a document, assigns priorities to important portions in the document from the user's viewpoint, and displays the important portions based on the assigned priorities, thereby raising the recognition rate of important information in the document.

The disclosed technology may assist in improving a recognition rate of important information in documents.

The preferred embodiments are described above. The embodiments of the present invention are illustrated with specific examples; however, the present invention is not limited to these examples, and various alterations or changes may be made without departing from the gist and the scope of the claims of the present invention. Specifically, the present invention shall not be construed as being limited to details of the specific examples and accompanying drawings thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. A reading comprehension assistance apparatus comprising:
one or more processors programmed to execute a process including
acquiring information indicating behavior with respect to attention portions of respective users who read a document;
specifying a user who properly reads the document based on the acquired information indicating behavior of the attention portions;
estimating one or more high attention portions having attention focused on by the high-reliability users who have properly read the document based on the information indicating the behavior with respect to the attention portions; and
presenting the one or more high attention portions.

2. The reading comprehension assistance apparatus according to claim 1, wherein
the acquiring information includes acquiring a time at which the behavior is detected, a character string at an attention position being focused on, and a position of the character string in the document.

3. The reading comprehension assistance apparatus according to claim 1, wherein
the specifying high-reliability users who have properly read the document includes specifying the high-reliability users based on information including a time during which the high-reliability users read the document, and a range of the document read by the high-reliability users.

4. The reading comprehension assistance apparatus according to claim 1, wherein
the estimating high attention portions includes estimating each of high attention portions based on an overlapped portion of the attention portions between the plurality of users.

5. The reading comprehension assistance apparatus according to claim 1, wherein
the presenting high attention portions includes presenting high attention portions in a descending order of mean reference time of the high attention portions being referred to by the high-reliability users who have properly read the document.

6. The reading comprehension assistance apparatus according to claim 5, wherein
the presenting high attention portions includes presenting a predetermined number of the high attention portions in the descending order of the mean reference time with color for attracting attention and a button for confirmation.

7. The reading comprehension assistance apparatus according to claim 1, wherein
the presenting high attention portions includes presenting a ratio of a number of high-reliability users who have properly read the document and have attention focused on each of the high attention portions with respect to a total number of the high-reliability users who have properly read the document.

8. A non-transitory computer-readable recording medium having a reading comprehension assistance program stored therein for causing one or more processors of a reading comprehension assistance apparatus to execute a process, the process comprising:
acquiring information indicating behavior with respect to attention portions of respective users who read a document;
specifying a user who properly reads the document based on the acquired information indicating behavior of the attention portions;
estimating one or more high attention portions having attention focused on by the high-reliability users who have properly read the document based on the information indicating the behavior with respect to the attention portions; and
presenting the one or more high attention portions.

9. The non-transitory computer-readable storage medium according to claim 8, wherein
the acquiring information includes acquiring a time at which the behavior is detected, a character string at an attention position being focused on, and a position of the character string in the document.

10. The non-transitory computer-readable recording medium according to claim 8, wherein
the specifying high-reliability users who have properly read the document includes specifying the high-reliability users based on information including a time during which the high-reliability users read the document, and a range of the document read by the high-reliability users.

11. The non-transitory computer-readable recording medium according to claim 8, wherein
the estimating high attention portions includes estimating each of high attention portions based on an overlapped portion of the attention portions between the plurality of users.

12. The non-transitory computer-readable recording medium according to claim 8, wherein
the presenting high attention portions includes presenting high attention portions in a descending order of mean reference time of the high attention portions being referred to by the high-reliability users who have properly read the document.

13. The non-transitory computer-readable recording medium according to claim 12, wherein
the presenting high attention portions includes presenting a predetermined number of the high attention portions in the descending order of the mean reference time with color for attracting attention and a button for confirmation.

14. The non-transitory computer-readable recording medium according to claim 8, wherein
the presenting high attention portions includes presenting a ratio of a number of high-reliability users who have properly read the document and have attention focused on each of the high attention portions with respect to a total number of the high-reliability users who have properly read the document.

15. A reading comprehension assistance method executed by a computer, the reading comprehension assistance method comprising:
acquiring information indicating behavior with respect to attention portions of respective users who read a document;
specifying a user who properly reads the document based on the acquired information indicating behavior of the attention portions;
estimating one or more high attention portions having attention focused on by the high-reliability users who have properly read the document based on the information indicating the behavior with respect to the attention portions; and
presenting the one or more high attention portions.

16. The reading comprehension assistance method according to claim 15, wherein
the acquiring information includes acquiring a time at which the behavior is detected, a character string at an attention position being focused on, and a position of the character string in the document.

17. The reading comprehension assistance method according to claim 15, wherein
the specifying high-reliability users who have properly read the document includes specifying the high-reliability users based on information including a time during which the high-reliability users read the document, and a range of the document read by the high-reliability users.

18. The reading comprehension assistance method according to claim 15, wherein
the estimating high attention portions includes estimating each of high attention portions based on an overlapped portion of the attention portions between the plurality of users.

19. The reading comprehension assistance method according to claim 15, wherein
the presenting high attention portions includes presenting high attention portions in a descending order of mean reference time of the high attention portions being referred to by the high-reliability users who have properly read the document.

20. The reading comprehension assistance method according to claim 19, wherein
the presenting high attention portions includes presenting a predetermined number of the high attention portions in the descending order of the mean reference time with color for attracting attention and a button for confirmation.
